(19) United States
(12) Patent Application Publication
(10) Pub. No.: US 2014/0168395 A1
(43) Pub. Date: Jun. 19, 2014

(54) THREE-DIMENSIONAL IMAGE DISPLAY DEVICE

(71) Applicant: Toru Iwane, Yokohama-shi (JP)

(72) Inventor: Toru Iwane, Yokohama-shi (JP)

(73) Assignee: NIKON CORPORATION, TOKYO (JP)

(21) Appl. No.: 14/238,285

(22) PCT Filed: Aug. 24, 2012
(86) PCT No.: PCT/JP2012/071482

§ 371 Date: Feb. 11, 2014

(30) Foreign Application Priority Data
Aug. 26, 2011 (JP) 2011-184728
Aug. 22, 2012 (JP) 2012-182953

(51) Int. Cl. H04N 13/04

(52) U.S. Cl. CPC H04N 13/0406
USPC 348/59

(57) ABSTRACT

A three-dimensional image display device includes: an input unit that inputs image data; a first image conversion unit that converts the image data to first image display data which include 2-D information; a display unit having a plurality of display pixels disposed in a two-dimensional pattern, which emits light fluxes from the plurality of display pixels in correspondence to the first image display data; and a micro-lens array having a plurality of micro-lenses disposed in a two-dimensional pattern, via which a three-dimensional image or a two-dimensional image is formed by combining the light fluxes emitted from the plurality of display pixels.

### TECHNICAL FIELD

The present invention relates to a three-dimensional image display device.

### BACKGROUND ART

There are display devices known in the related art that are capable of displaying stereoscopic images and planar images (see, for instance, patent literature 1).

### CITATION LIST

### Patent Literature

Patent literature 1: Japanese laid open patent publication No. H10-227995

### SUMMARY OF INVENTION

### Technical Problem

There is an issue yet to be effectively addressed in the prior art, in that a two-dimensional image and a three-dimensional image cannot be displayed together on a single screen without compromising the image quality of the two-dimensional image.

According to the 1st aspect of the present invention, a three-dimensional image display device comprises: an input unit that inputs image data; a first image conversion unit that converts the image data to first image display data which include 2-D information; a display unit having a plurality of display pixels disposed in a two-dimensional pattern, which emits light fluxes from the plurality of display pixels in correspondence to the first image display data; and a micro-lens array having a plurality of micro-lenses disposed in a two-dimensional pattern, via which a three-dimensional image or a two-dimensional image is formed by combining the light fluxes emitted from the plurality of display pixels.

According to the 2nd aspect of the present invention, the three-dimensional image display device according to the 1st aspect may further comprise: a second image conversion unit that converts the image data to second image display data which include 3-D information, wherein: the display unit emits light fluxes from the plurality of display pixels in correspondence to the first image display data and the second image display data.

According to the 3rd aspect of the present invention, it is preferred that in the three-dimensional image display device according to 2nd aspect: the three-dimensional image and the two-dimensional image are displayed on a single plane.

According to the 4th aspect of the present invention, a three-dimensional image display device comprises: a display unit having a plurality of display pixel clusters disposed in a two-dimensional array, each of the plurality of display pixel clusters including a plurality of display pixels disposed in a two-dimensional pattern; a plurality of optical members disposed, each in correspondence to one of the plurality of display pixel clusters, in a two-dimensional array, which project the corresponding display pixel clusters; a three-dimensional image data output unit that outputs three-dimensional image data; a first display control unit that displays the three-dimensional image data as a three-dimensional image via the optical members by controlling the display pixels based upon the three-dimensional image data; a two-dimensional image data output unit that outputs two-dimensional image data; a conversion unit that divides the two-dimensional image data into a plurality of two-dimensional image data segments and converts each of the two-dimensional image data segments into a plurality of two-dimensional image display data segments; and a second display control unit that controls the display pixel clusters each corresponding to the plurality of two-dimensional image display data segments based upon the two-dimensional image display data segments so as to display each set of the two-dimensional image data as a two-dimensional image by synthetically generating a projected image via the optical members related to the plurality of display pixel clusters corresponding to the plurality of sets of two-dimensional image display data.

According to the 5th aspect of the present invention, a three-dimensional image display device comprises: a display unit having a plurality of display pixel clusters disposed in a two-dimensional pattern, each of the plurality of display pixel clusters including a plurality of display pixels disposed in a two-dimensional pattern; a plurality of optical members disposed, each in correspondence to one of the plurality of display pixel clusters, in a two-dimensional array, which project the corresponding display pixel clusters; a three-dimensional image data output unit that outputs three-dimensional image data; a first display control unit that displays the three-dimensional image data as a three-dimensional image via the optical members by controlling the display pixels based upon the three-dimensional image data; a two-dimensional image data output unit that outputs two-dimensional image data; a conversion unit that divides the two-dimensional image data into a plurality of two-dimensional image data segments and converts each of the two-dimensional image data segments into a plurality of two-dimensional image display data segments; a second display control unit that controls the display pixel clusters each corresponding to the plurality of two-dimensional image display data segments based upon the two-dimensional image display data segments so as to display each set of the two-dimensional image data as a two-dimensional image by synthetically generating a projected image via the optical members related to the plurality of display pixel clusters corresponding to the plurality of sets of two-dimensional image display data; and a third display control unit that brings up the three-dimensional image and the two-dimensional image on display on a single screen by controlling the display unit.

According to the 6th aspect of the present invention, the three-dimensional image display device according to the 4th aspect may further comprise: a third display control unit that brings up the three-dimensional image and the two-dimensional image on display on a single screen by controlling the display unit.

According to the 7th aspect of the present invention, the three-dimensional image display device according to any one of the 4th through 6th aspects may further comprise: an extraction unit that extracts 2-D information included in the three-dimensional image data, wherein: the two-dimensional image data output unit outputs the 2-D information extracted by the extraction unit, as the two-dimensional image data.

According to the 8th aspect of the present invention, it is preferred that in the three-dimensional image display device according to any one of the 4th through 7th aspects: the conversion unit is configured with a 2-D member having the two-dimensional image display data segments reproduced thereat and is disposed between the optical members and the display pixels in relation to a direction along optical axis of the optical members extend.

According to the 9th aspect of the present invention, it is preferred that in the three-dimensional image display device according to any one of the 4th through 8th aspects: the optical members project the two-dimensional image onto lens surfaces of the optical members or onto an image plane in space, the image plane in space being set apart by a distance equal to a focal length of the optical members or more.

According to the 10th aspect of the present invention, it is preferred that in the three-dimensional image display device according to any one of the 4th through 9th aspects: the optical members are each constituted with a micro-lens or a cylindrical lens.

### Advantageous Effect of the Invention

According to the present invention, whereby a projected image is synthetically generated via optical members related to a plurality of display pixel clusters corresponding to a plurality of sets of two-dimensional image display data, two-dimensional image data can be displayed as a two-dimensional image and, furthermore, a three-dimensional image and a two-dimensional image can be displayed on the same screen.

### BRIEF DESCRIPTION OF THE DRAWINGS

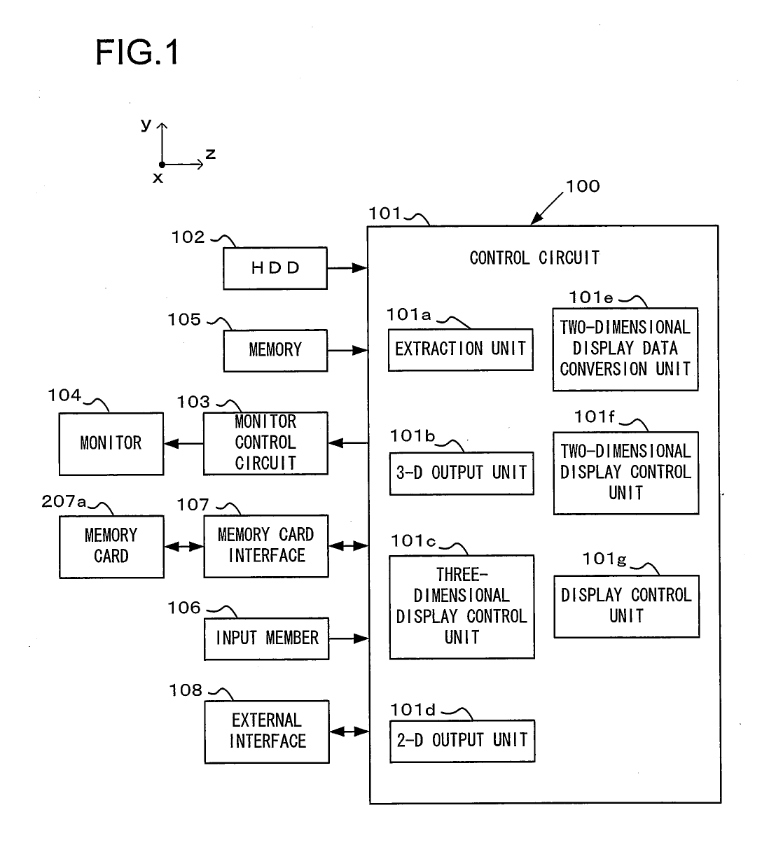

(FIG. 1) A block diagram illustrating the essential structure of the three-dimensional image display device achieved in an embodiment of the present invention

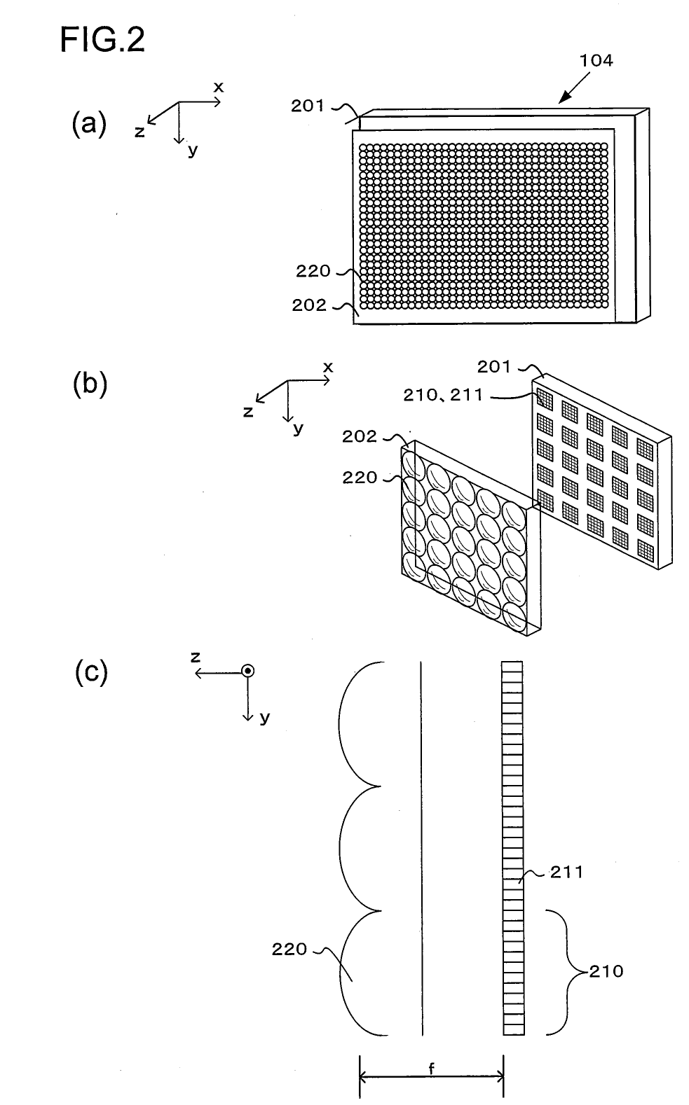

(FIG. 2) Illustrations presenting an example of a structure that may be adopted in the monitor in the three-dimensional display device achieved in the embodiment

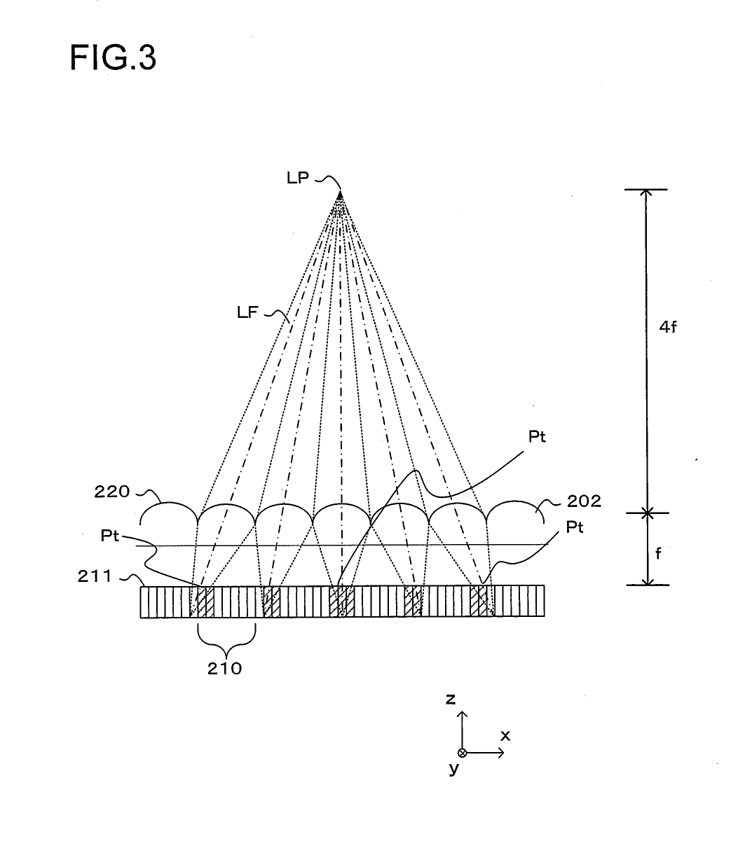

(FIG. 3) A schematic illustration of the relationship among display pixels, the display micro-lens array and the luminous point that is displayed

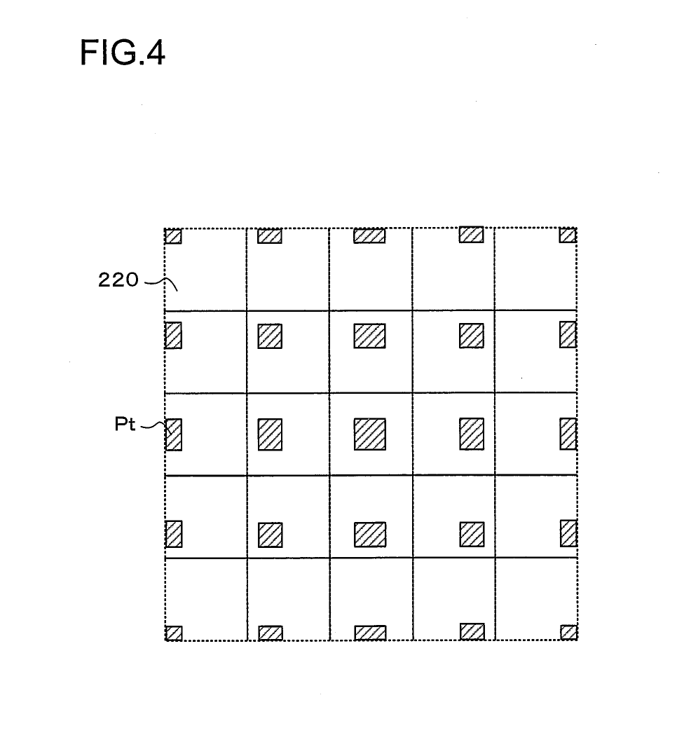

(FIG. 4) A two-dimensional development representation of the concept illustrated in FIG. 3

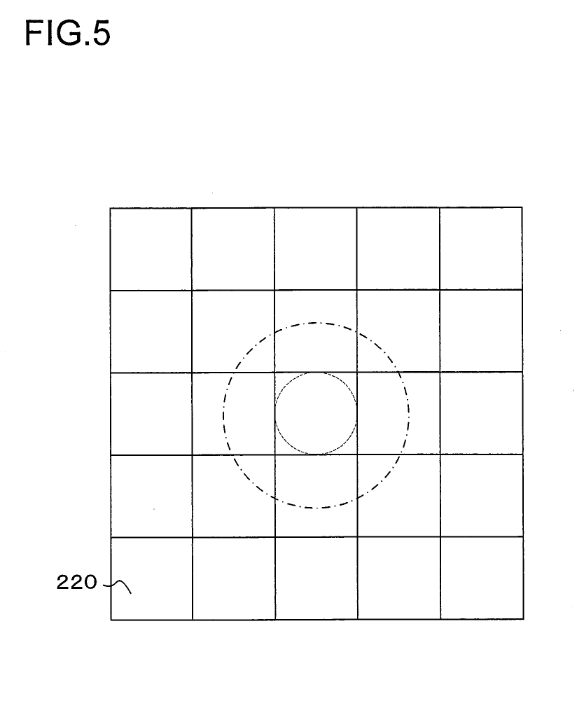

(FIG. 5) A diagram illustrating the relationships between display micro-lenses and pattern light sections

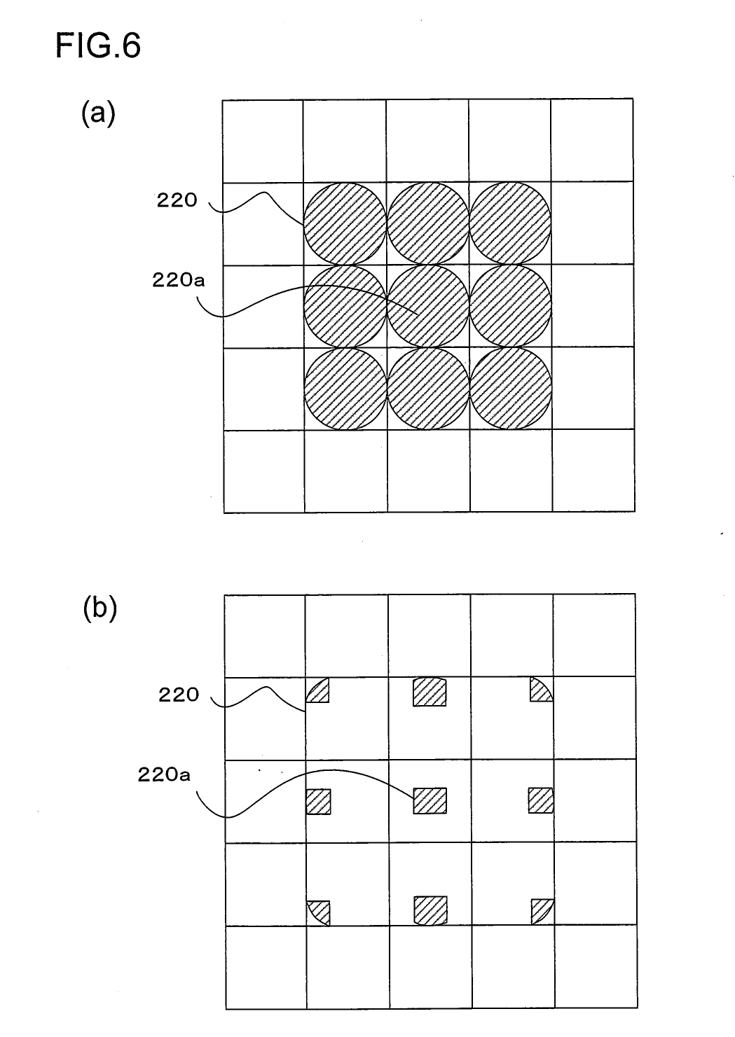

(FIG. 6) Illustrations in reference to which the relationship between display micro-lenses and a pattern is to be explained

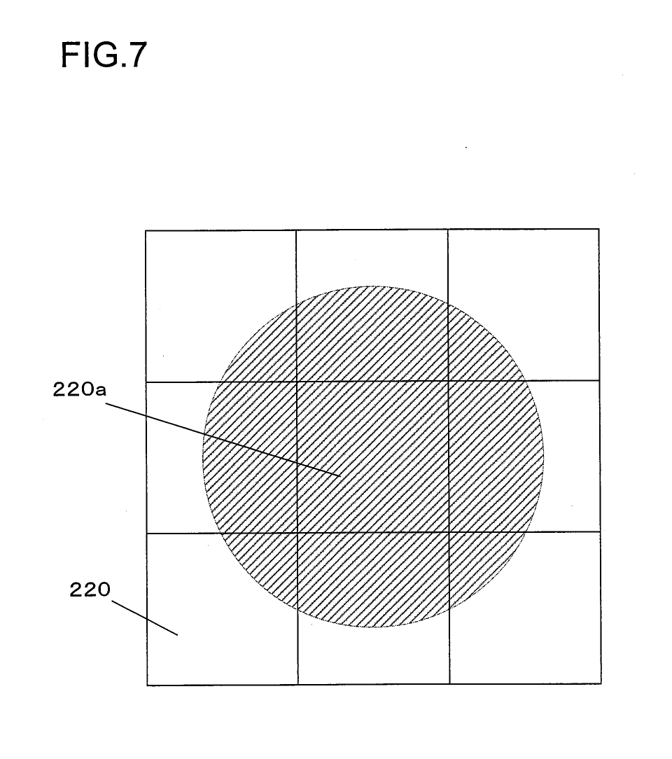

(FIG. 7) A pattern resulting from an areal division implemented for a cardinal point micro-lens

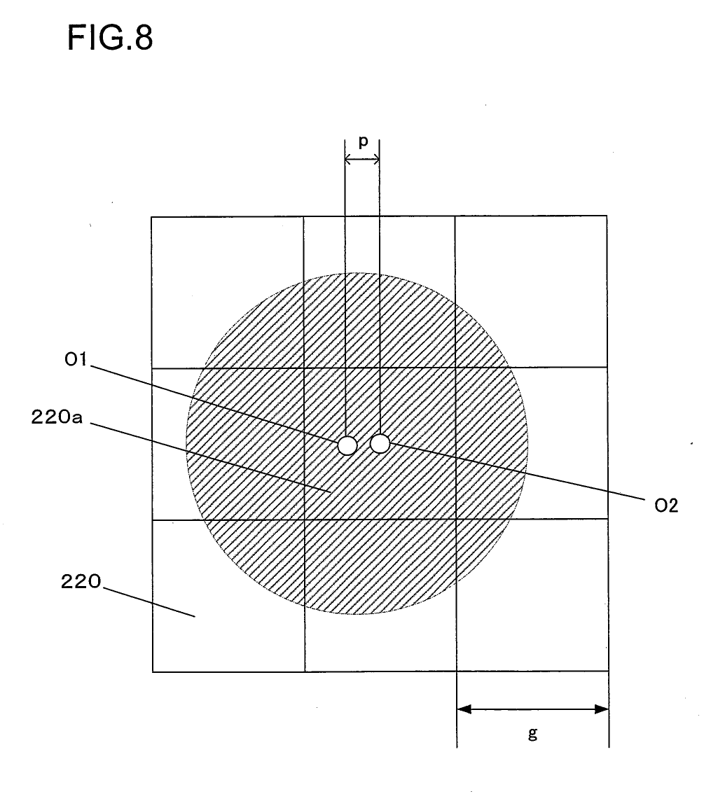

(FIG. 8) An illustration of a pattern formed in correspondence to a luminous point off-centered relative to the central position of a cardinal point micro-lens

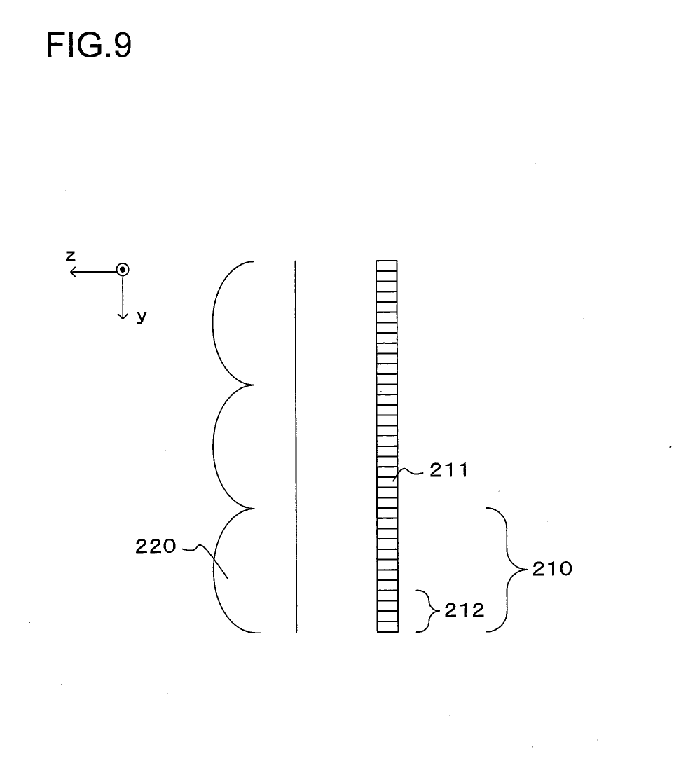

(FIG. 9) An illustration of display pixels used for two-dimensional image display

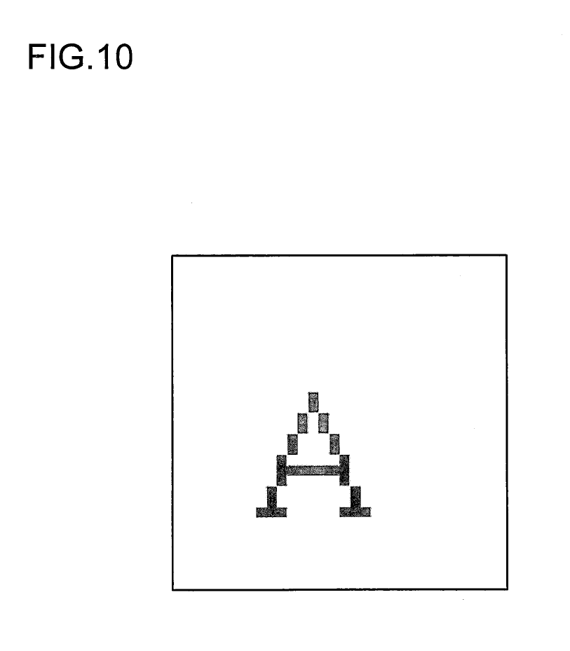

(FIG. 10) An example of an image that may be brought up as a two-dimensional display

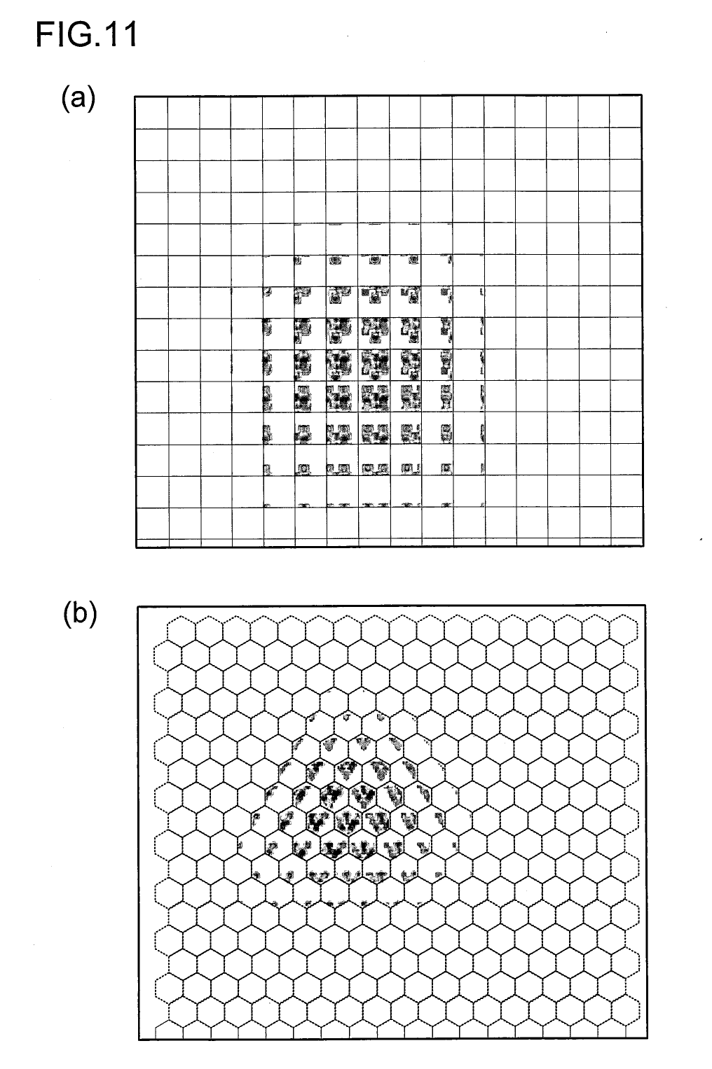

(FIG. 11) Illustrations of pattern allocations for two-dimensional image display

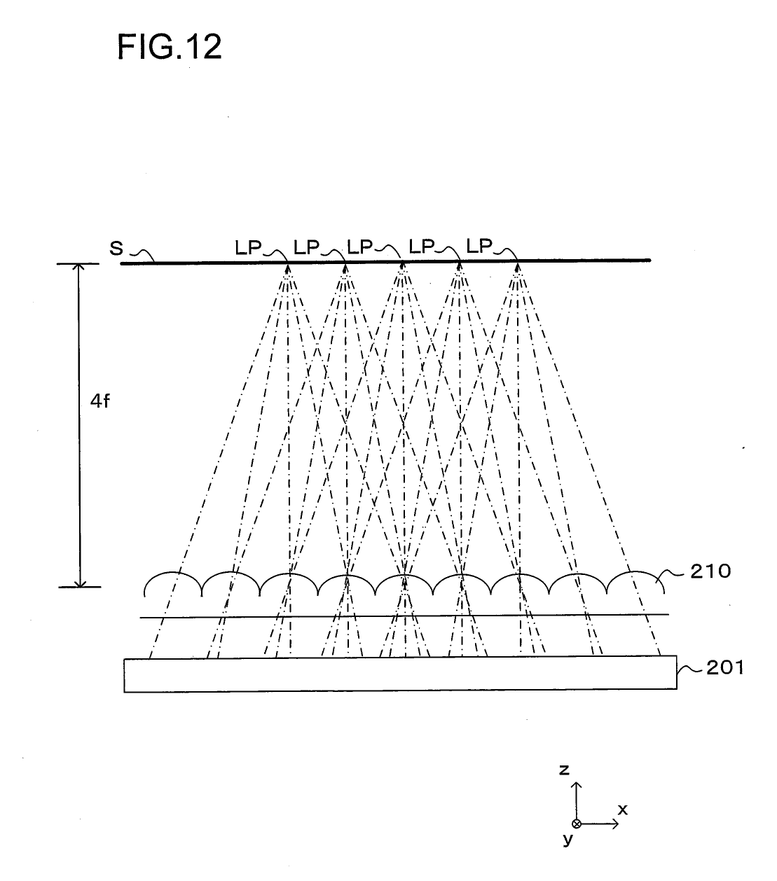

(FIG. 12) A schematic diagram illustrating how the pattern in FIG. 11 is displayed as a two-dimensional image on a spatial image display plane

### DESCRIPTION OF EMBODIMENT

The three-dimensional image display device in the embodiment is configured with a personal computer or the like that includes a monitor used to display images. This three-dimensional image display device is capable of displaying an image corresponding to image data that include 3-D information, generated in a plenoptic camera, a light field camera or the like in the known art, so that the image can be viewed as a three-dimensional image. In addition, an image expressed by image data corresponding to 2-D information related to, for instance, a character, a command button via which various types of operations are input, or the like, is displayed so that it can be viewed as a two-dimensional image at this three-dimensional image display device. The following is a detailed description of the three-dimensional image display device.

FIG. 1 is a block diagram showing the essential structure of a three-dimensional image display device 100 achieved in the embodiment. The three-dimensional image display device 100 comprises a control circuit 101, an HDD 102, a monitor control circuit 103, a monitor 104, a memory 105, an input member 106, a memory card interface 107 and an external interface 108.

The input member 106 is an operation member such as a keyboard that includes switches and buttons operated by the user or a mouse. The input member 106 is operated by the user wishing to select a specific menu item or a setting in a menu screen brought up on display at the monitor 104 so as to have processing corresponding to the selected menu item or setting executed.

In the HDD 102, an image file corresponding to a movie image or a still image taken with, for instance, a digital camera, and the like are recorded. The external interface 108 is engaged in data communication with an external device such as a digital camera via, for instance, a USB interface cable or a wireless transmission path. The three-dimensional image display device 100 takes in an image file or the like from a memory card 207a via the memory card interface 107 or from an external device via the external interface 108. The image file thus input is recorded into the HDD 102 under control executed by the control circuit 101. An image file having been generated in a digital camera is recorded into the HDD 102 by the control circuit 101. In addition, various programs and the like, executed by the control circuit 101, are recorded in the HDD 102.

The control circuit 101 is a microcomputer that controls the three-dimensional image display device 100 and is configured with a CPU, a ROM and other peripheral circuits. The control circuit 101 fulfills functions embodied in functional units; an extraction unit 101a, a 3-D output unit 101b, a three-dimensional display control unit 101c, a 2-D output unit 101d, a two-dimensional display data conversion unit 101e, a two-dimensional display control unit 101f and a display control unit 101g. The extraction unit 101a extracts 2-D information, included in image data containing 3-D information (hereafter referred to as three-dimensional image data), as two-dimensional display data. The 2-D information relates to a character, a command button via which various types of operations are input as explained earlier, a window frame or the like. The 3-D output unit 101b reads out three-dimensional image data recorded in, for instance, the HDD 102. The three-dimensional display control unit 101c displays the three-dimensional image data as a three-dimensional image by controlling display pixels included in the monitor 104, which will be described in detail later, based upon the three-dimensional image data.

The 2-D output unit 101d reads out two-dimensional image data recorded in, for instance, the HDD 102. The two-dimensional display data conversion unit 101e divides the two-dimensional display data having been extracted by the extraction unit 101a and the two-dimensional image data having been read out by the 2-D output unit 101d into a plurality of two-dimensional image data segments. The two-dimensional display data conversion unit 101e then converts each two-dimensional image data segment into a plurality of two-dimensional image display data segments. In other words, the two-dimensional display data conversion unit 101e converts image data into two-dimensional image display data segments containing 2-D information. The two-dimensional display control unit 101f displays the two-dimensional image data and the two-dimensional display data as a two-dimensional image by controlling the display pixels at the monitor 104, which will be described in detail later, based upon the two-dimensional image display data segments. The display control unit 101g displays the three-dimensional image and the two-dimensional image together on a single screen, i.e., at the monitor 104. It is to be noted that the extraction unit 101a, the 3-D output unit 101b, the three-dimensional display control unit 101c, the 2-D output unit 101d, the two-dimensional display data conversion unit 101e, the two-dimensional display control unit 101f and the display control unit 101g will be described in further detail later.

The memory 105, which is used as a working memory for the control unit 101, may be configured with, for instance, an SDRAM. At the monitor 104, which may be, for instance, a liquid crystal monitor, an image corresponding to image display data, a menu screen in which various settings may be selected, and the like are brought up on display under control executed by the monitor control circuit 103.

In reference to FIG. 2, the monitor 104 will be described. It is to be noted that in FIG. 2, a coordinate system is defined with an x-axis running along the width of the display screen at the monitor 104 in the horizontal direction, a y-axis running along the height of the display screen at the monitor 104 in the vertical direction and a z-axis running perpendicular to the x-y plane (i.e., the display screen at the monitor 104). FIG. 2(a) shows the monitor 104 in a perspective taken from the user side along the z-axis, FIG. 2(b) is a partial enlargement of FIG. 2(a), and FIG. 2(c) is a schematic sectional view of the monitor 104 showing its configuration along the z-axis.

As FIGS. 2(a) and 2(b) show, the monitor 104 includes a display unit 201 and a display micro-lens array 202. The display unit 201, which may be a liquid crystal display unit or an organic EL display unit with a backlight, includes a plurality of display pixel clusters 210 disposed in a two-dimensional array. The plurality of display pixel clusters 210 each include a plurality of display pixels 211 disposed in a two-dimensional pattern. It is to be noted that each display pixel cluster 210 is made up with 16×16 display pixels 211 in the embodiment. However, in order to simplify the illustrations, FIG. 2 shows fewer display pixels 211 than the number of the display pixels 211 that are actually present at the monitor. The display pixels 211 emit light in correspondence to the image display data under control executed by the monitor control circuit 103 mentioned earlier.

The display micro-lens array 202 is constituted with a plurality of display micro-lenses 220 disposed in a two-dimensional array. As shown in FIG. 2(b), the display micro-lenses 220 are disposed in a positional pattern whereby they each correspond to one of the plurality of display pixel clusters 210. In addition, as FIG. 2(c) indicates, the display micro-lens array 202 is disposed further toward the user along the z-axis, at a position set apart from the display pixels 211 by a distance equal to the focal length f of the display micro-lenses 220. Light emitted from the display pixels 211 in correspondence to the image data is projected via the individual display micro-lenses 220 onto a specific image plane located toward the user along the z-axis.

The principle adopted for three-dimensional image display at the monitor 104 will be explained next. The display principle adopted for the monitor 104 is the reverse of the plenoptic principle. First, in reference to FIG. 3, the plenoptic principle will be briefly explained.

FIG. 3 shows the relationship among display pixels 211, the display micro-lens array 202 and the luminous point LP that is to be displayed. As explained earlier, the display micro-lens array 202 is disposed at a position set apart from the display pixels 211 by a distance equal to the focal length of the display micro-lenses 220 along the z-axis. It is to be noted that FIG. 3 shows the luminous point LP assuming a position further toward the user, set apart from the display micro-lens array 202 by a distance 2f along the z-axis.

The principle of plenoptics is applicable in the path of a light flux LF traveling from the luminous point LP toward the display pixels 211. The light flux LF traveling from the luminous point LP passes through a plurality of display micro-lenses 220 and achieves focus at a position set apart from the display micro-lenses 220 by a distance 4f/3. However, since the display micro-lenses 220 are disposed at positions set apart from the display pixels 211 by the distance f along the z-axis, the light flux LF having passed through each display micro-lens 220 forms an image assuming a certain expansive range over display pixels 211 corresponding to the particular display micro-lens 220 through which the light flux LF has passed. In the following description, this image assuming an expansive range will be referred to as a light section and the term “pattern PT” will be used to refer to the grouping of light sections defined by specific section shapes.

FIG. 4 shows the pattern Pt explained above in a two-dimensional development. It is to be noted that for purposes of simplification, FIG. 4 shows the display micro-lenses 220 is disposed in a square array. In the principle of plenoptics, the luminous intensity (luminance) of the luminous point LP in FIG. 3 is distributed over the pattern Pt, as shown in FIG. 4. In FIG. 4, the pattern Pt is indicated as shaded areas.

At the monitor 104 adopting a principle that is the reverse of the plenoptic principle described above, a spatial image with depth is displayed by projecting light fluxes emitted from the display pixels 211 via the display micro-lenses 220. More specifically, the pattern Pt shown in FIG. 4 is allocated to specific display pixels 211 at the display unit 202. In the exact reversal of the situation described in reference to FIG. 3, light emitted from the display pixels 211 allocated with the pattern Pt is projected via the display micro-lenses 220 and forms an image at the luminous point LP. The light fluxes emitted from the display pixels 211 defining each pattern Pt and advancing along multiple directions include light fluxes advancing along the direction converging on the luminous point LP, i.e., light fluxes emitted at angles matching the angles of incidence with which the incoming light flux LF mentioned above enters the display pixels 211. For this reason, a spatial image is formed at the position set apart from the display micro-lens array 202 along the z-axis by the distance 4f.

In reference to FIG. 5, illustrating widening light fluxes LF from luminous points LP, which advance as their diameters increase, and are then projected onto display micro-lenses 220, the correspondence between a given pattern Pt and a specific number of display micro-lenses 220 or a specific macro lens 220 will be explained. It is to be noted that FIG. 5 shows light fluxes LF that widen as they travel from a luminous point LP assuming a position along the z-axis, which is equal to the focal length f of the display micro-lenses 220, and from a luminous point LP assuming a position along the z-axis, which is equivalent to double the focal length f, i.e., 2f. In FIG. 5, the expanse of the light flux LF from the luminous point LP taking up the position equivalent to the focal length f along the z-axis is indicated with the dotted line, whereas the expanse of the light flux LF from the luminous point LP taking up the position equivalent to the distance 2f along the z-axis is indicated with the one-point chain line. The expanse of the light flux LF from the luminous point LP taking up the position equivalent to the focal length f of the display micro-lenses 220 is defined by a specific display micro-lens 220 and thus, the light flux LF enters the single display micro-lens 220. As a result, the specific display micro-lens 220 corresponding to the particular luminous point LP is determined.

The light flux LF having traveled from the luminous point LP taking up the position equivalent to the focal length f of the display micro-lenses 220 along the z-axis spreads as light with a circular section over the entire area directly under the specific display micro-lens 220. Thus, as all the display pixels 211 present in the circle inscribed within the square area emit light, the pattern Pt is projected and a spatial image is formed at the luminous point LP. If the absolute value representing the position of the luminous point LP taken along the z-axis is less than the focal length f, the light flux LF spreads without converging within the area directly under the display macro lens 220. However, since the largest aperture opening (smallest F number) is defined by the F number of the display micro-lenses 220, the angle with which the light flux LF having traveled from the luminous point LP widens as it enters the display micro-lens 220 is restricted and the pattern Pt is contained within the coverage area.

The pattern of the light flux traveling from the luminous point LP assuming the position equivalent to the distance 2f along the z-axis will be explained next. FIG. 6 shows the micro-lenses 220 through which the light flux passes in this situation. As shown in FIG. 6(a), the light flux passes through the principal display micro-lenses 220, i.e., the display micro-lens 220 disposed coaxially to the luminous point LP along the z-axis (hereafter referred to as a cardinal point micro-lens 220a) and eight display micro-lenses 220 adjacent to the cardinal point micro-lens 220a. Due to the aperture restriction at the display micro-lenses 220, the pattern Pt is bound to be contained within the shaded coverage areas in FIG. 6(a). The shaded areas in FIG. 6(b), corresponding to the various display micro-lenses 220, define the pattern P.

As FIG. 6(b) indicates, the coverage area corresponding to a single cardinal point micro-lens 220a is divided and the resulting coverage area portions are allocated to the adjacent display micro-lenses 220. If the coverage area portions (areal segments) resulting from this division and allocated to the other display micro-lenses 220 are integrated, the combined entire area matches the aperture area of a single display micro-lens 220. This means while the position of the luminous point LP may vary, the size of the entire area taken up by the pattern Pt remains unchanged. Thus, the specific display micro-lenses 220 to which the individual areal segments belong simply need to be determined when calculating the entire area by integrating the areal segments.

The relationship between the position of the luminous point LP taken along the z-axis and the magnification factor, i.e., the quantity of display micro-lenses 220 around the cardinal point micro-lens 220a, having been described in reference to FIG. 5, is expressed through the concept of a virtual aperture area. For instance, the aperture area may be divided over an array of display micro-lenses 220 reduced by a specific magnification factor and fragments of the aperture area may be distributed to the matching positions within the display micro-lenses 220 thus defined. An explanation will be given below on an example in which the square circumscribed on the aperture area is reduced at a magnification factor of 2 and the aperture area is divided (areal division) over display micro-lenses 220 in the array.

FIG. 7 shows a pattern Pt formed over micro-lenses with the aperture area divided as described above in correspondence to a cardinal point micro-lens 220a. The pattern corresponding to the magnification factor, i.e., the luminous point LP, can be obtained by executing similar areal division in correspondence to the magnification factor. In more specific terms, the aperture area is divided in a lattice pattern with each grid assuming a width of g/m with g representing the diameter of the display micro-lenses 220 (the length of a side of each micro-lens). The magnification factor can be expressed as; ratio m=y/f of the height (position) y of the luminous point LP and the focal length f of the micro-lenses. The ratio m may take on a negative value. If the sign attached to the ratio m is minus, the luminous point LP is assumed to be present further toward the display pixels 211 relative to the display micro-lenses 220.

The product of the coverage area covered in correspondence to each display micro-lens 220 and the quantity of display micro-lenses 220 is equal to the entire number of display pixels 211 included in the display pixel clusters 210. This means that forming luminous points LP each corresponding to one of a plurality of decentered points within one display micro-lens 220 is equivalent to superimposing patterns Pt reproduced at the display pixels 211 and projecting the superimposed patterns Pt. In other words, light fluxes LF from the various decentered luminous points LP, superimposed upon one another, are present on the display pixels 211. However, when the magnification factor is 1, this arithmetic operation will be a simple interpolation operation that does not substantially contribute to an improvement in resolution. This fact indicates that information related to the optical depth will be lost in an image formed at a point near the vertex of a display micro-lens 220.

FIG. 8 illustrates the areal division implemented for a luminous point LP decentered to the left relative to the center of a cardinal point micro-lens 220a. The following description will be given by assuming that the luminous point LP is decentered by an extent p to the left in FIG. 8 relative to the center of the cardinal point micro-lens 220a (with a lens diameter g) and that the luminous point LP assumes a height (position) 2f. It is to be noted that a point O1 and a point O2 in FIG. 8 respectively indicate the position of the decentered luminous point LP and the center of the display micro-lens 220. The areal division shown in FIG. 8 is achieved by shifting the display micro-lenses 220 in FIG. 7 by the extent p to the right in FIG. 7 and dividing the aperture area in the offset state.

In correspondence to each display micro-lens 220, a group of sixteen luminous points, for instance, may be obtained by dividing the display micro-lens 220 into sixteen areas, defining patterns at −g/2, −g/4, 0, g/4 and g/2 both along the x-axis and along the y-axis with the center of the display micro-lens 220 assuming coordinate values (0, 0), and integrating the corresponding areal segments over the entire area.

Next, the principle of two-dimensional display, whereby 2-D information, such as a character, is displayed as a spatial image, will be explained. In order to simplify the description, the 16×16 display pixels 211 in each display pixel cluster 210 corresponding to a specific display micro-lens 220 will be represented by a system configured with 4×4 combination display pixels 212, as shown in FIG. 9. The pattern Pt expressed with the two-dimensional image data to be brought up as a two-dimensional display is allocated to display pixels by regarding each combination display pixel 212 as a single pixel.

FIG. 10 presents an example of an image, i.e., the letter “A”, to be brought up in two-dimensional display. In order to bring up a two-dimensional display of the letter “A” in FIG. 10 at the position set apart by a distance 2f along the z-axis from the display micro-lenses 220, the pattern Pt is allocated to the combination display pixels 212 as shown in FIG. 11. It is to be noted that FIG. 11(a) shows the pattern allocation for display micro-lenses 220 disposed in a square array, whereas FIG. 11(b) shows the pattern allocation for display micro-lenses 220 disposed in a honeycomb array. With the pattern Pt allocated to the combination display pixels 212 as shown in FIG. 11, the letter “A” is brought up in two-dimensional display as a spatial image on a spatial image display plane S formed at the position set apart from the display micro-lenses 220 by the distance 2f along the z-axis as shown in FIG. 12. It is to be noted that the spatial image display plane S does not need to be formed at the position set apart by the distance 4f. Namely, it may be formed at any position set apart from the display micro-lenses 220 by a distance equal to or greater than their focal length f or it may be formed on the plane flush with the lens surfaces of the display micro-lenses 220. The user is able to form the spatial image display plane S at a desired position by operating the input member 106.

In order to allow a two-dimensional image such as a character to be displayed as a spatial image, various luminous points LP, which are to constitute the spatial image, need to be synthetically generated. As explained earlier, each luminous point LP is formed by synthetically generating a projected image, via display micro-lenses 220, of the pattern Pt allocated to the sixteen combination display pixels 212 included in the coverage area corresponding to a single display micro-lens 220. This means that if one display micro-lens 220 contributes to the formation of sixteen luminous points LP, an output achieved by multiplying the outputs from the combination display pixels 212 present in the coverage area corresponding to the display micro-lens 220 by 16 will be required, and all the outputs will need to be synthetically generated. More specifically, as the individual combination display pixels 212 used to form a single luminous point LP are allocated with various areal sizes, outputs are distributed at an adjacent luminous point LP so as to add to the outputs at the combination display pixels 212. In other words, the outputs from the sixteen combination display pixels 212 are superimposed upon one another in correspondence to each luminous point LP, requiring, therefore, up to a sixteen-fold increase in the dynamic range for the pixel outputs.

The control circuit 101 in the three-dimensional image display device 100 displays a two-dimensional image such as a character on the spatial image display plane S formed at a predetermined height and set apart from the display micro-lens array 202 along the z-axis, by allocating the pattern Pt over the display pixels 211 as has been described in reference to FIG. 11. For these purposes, the 2-D output unit 101d reads out two-dimensional image data to be displayed as a two-dimensional image at the monitor 104 from the HDD 102. The content of the two-dimensional image read out by the 2-D output unit 101d is identical to that of image data output to a display unit used for regular two-dimensional image display.

The two-dimensional display data conversion unit 101e divides the two-dimensional image data having been read out by the 2-D output unit 101d into image data segments corresponding to a plurality of display micro-lenses 220. In the example presented in FIG. 10, the two-dimensional display data conversion unit 101e divides the two-dimensional image data into sixteen image data segments. The two-dimensional display data conversion unit 101e then generates two-dimensional image display data segments in correspondence to each of the image data segments resulting from the division. The two-dimensional image display data segments are image data expressing the pattern Pt that may be allocated as shown in FIG. 11. Once the two-dimensional image display data segments are generated, the two-dimensional display control unit 101f allocates the pattern Pt expressed by the image display data segments to various combination display pixels 212. In other words, the two-dimensional display control unit 101f issues a command for the monitor control unit 103 so as to emit light at the combination display pixels 212 disposed at the positions corresponding to the two-dimensional image display data segments.

The processing executed in the three-dimensional image display device 100 in order to display a three-dimensional image and a two-dimensional image at the single monitor 104 will be explained next. In this situation, the control circuit 101 in the three-dimensional image display device 100 may use, for instance, one of a plurality of windows brought up on display at the monitor 104 for the three-dimensional display and display another window, characters indicating various types of operation commands, or the like as a two-dimensional image. As an alternative, the control circuit 101 may provide a three-dimensional display of an image corresponding to specific image data at the monitor 104 and display the portion corresponding to the frame of the image in two-dimensional display.

The 3-D output unit 101b reads out three-dimensional image data to be displayed as a three-dimensional image at the monitor 104 from the HDD 102. The three-dimensional image data read output by the 3-D output unit 101b in this situation may be 3-D information obtained via, for instance, a plenoptic camera, i.e., image data expressing a pattern Pt. The extraction unit 101a then extracts two-dimensional display data constituted with information to be provided in two-dimensional display in correspondence to, for instance, a window frame or the like, which are included in the three-dimensional image data having been read out. The two-dimensional display data thus extracted are then converted to image display data segments by the two-dimensional display data conversion unit 101e mentioned earlier.

The three-dimensional display control unit 101c issues a command for the monitor control circuit 103 so as to generate three-dimensional image display data by using the image data remaining in the three-dimensional image data having been read out, which have not been extracted by the extraction unit 101a. Next, the three-dimensional display control unit 101c allocates the three-dimensional image display data, i.e., the pattern Pt expressing the 3-D information, to various display pixels 211, which then emit light accordingly. At this time, if the central positions (optical axes) of the micro-lenses in the plenoptic camera used to generate the three-dimensional image data are not in alignment with the central positions (optical axes) of the display micro-lenses 220, i.e., if the central axes of the display micro-lenses 220 and the luminous points LP are not coaxial along the z-axis, the three-dimensional display control unit 101c executes normalization processing for the three-dimensional image data having been read out. Namely, the three-dimensional display control unit 101c shifts the three-dimensional image data over the x-y plane so as to set the luminous points LP corresponding to various patterns Pt on the central axes of the respective cardinal point micro-lenses 220a.

The three-dimensional display control unit 101c generates three-dimensional image display data by converting the portions of the pattern Pt corresponding to the display micro-lenses 220 surrounding each cardinal point micro-lens 220a to positions achieving point symmetry centered on the cardinal point micro-lens 220a. While the direction along which light advances at a plenoptic camera engaged in image data acquisition and the direction along which light advances at the monitor 104 are opposite from each other, the recesses and projections of the spatial image along the depth-wise direction (along the z-axis) and the recesses and the projections along the depth-wise direction captured through the photographing operation are aligned through the processing described above. The three-dimensional display control unit 101c then allocates the pattern Pt expressed by the three-dimensional image display data thus generated over the display pixels 211.

The display control unit 101g controls the two-dimensional display control unit 101f and the three-dimensional display control unit 101c so as to display a three-dimensional image achieving depth along the z-axis and a two-dimensional image, brought up in two-dimensional display at a specific height along the z-axis, together on the same screen, i.e., at the monitor 104. At this time, the two-dimensional display control unit 101f issues a command for the monitor control circuit 103 so as to provide a two-dimensional display of the two-dimensional image corresponding to the two-dimensional image display data segments, such as a window frame, a character or an operation button, at the specific height relative to the monitor 104. In addition, the three-dimensional display control unit 101c issues a command for the monitor control circuit 103 so as to provide a three-dimensional display of the image corresponding to the three-dimensional image display data as a spatial image.

The three-dimensional image display device 100 in the embodiment described above achieves the following advantages.

(1) At the display unit 201, a plurality of display pixel clusters 210, each made up with a plurality of display pixels 211 disposed in a two-dimensional pattern, are disposed in a two-dimensional array. The plurality of display micro-lenses 220, disposed in a two-dimensional array each in correspondence to one of the plurality of display pixel clusters 210, project the corresponding display pixel clusters 210. The 3-D output unit 101b outputs three-dimensional image data, and the three-dimensional display control unit 101c controls the display pixels 211 based upon the three-dimensional image data so as to display the three-dimensional image data as a three-dimensional image via the display micro-lenses 210. The 2-D output unit 101d outputs two-dimensional image data, and the two-dimensional display data conversion unit 101e divides the two-dimensional image data into a plurality of two-dimensional image data segments and converts each two-dimensional image data segment into a plurality of two-dimensional image display data segments. Based upon the two-dimensional image display data segments, the two-dimensional display control unit 101f controls the display pixel clusters 210, each corresponding to a plurality of two-dimensional image display data segments, so as to display a two-dimensional image corresponding to the plurality of sets of two-dimensional image data by synthetically generating a projected image via the display micro-lenses 220 correlated to the plurality of display pixel clusters 210 corresponding to the plurality of two-dimensional image display data segments. As a result, 2-D information such as a character or a window frame is provided in two-dimensional display at the spatial image display plane S. In other words, since the 2-D information is not displayed as an image having depth along the z-axis, the user is able to view the 2-D information with better ease.

In addition, sixteen combination display pixels 212 are set in correspondence to each micro-lens 220 and a pattern Pt is allocated over these sixteen combination display pixels. This means that a resolution 16 times higher than the resolution of an image generated by allocating information for one pixel to each display pixel cluster 210 is achieved, and the user is thus able to read fine letters or the like without any difficulty. It is to be noted that it is, in principle, possible to allocate a pattern Pt by setting 16×16 display pixels 211 in correspondence to each display micro-lens 220. However, the volume of data carried in 2-D information basically decreases via display micro-lenses 220. This factor is taken into account in the embodiment in which the image quality in the two-dimensional display is assured by setting the combination display pixels 212 so as to achieve a resolution lower than the array density of the display pixels 211. However, as long as the display unit 201 assures a sufficiently high level of gradation performance and thus, the information lost via the display micro-lenses 220 can be amply compensated, the pattern Pt may be allocated in correspondence to 16×16 display pixels 211.

The three-dimensional image display device 100, which is achieved in the embodiment by further expanding the concept of variable-focus image synthesis through a micro-lens array, synthetically generates information for one pixel by adding together the outputs from display pixels 211 covered by a plurality of display micro-lenses 220. Namely, display pixels 11 are extracted from the coverage areas covered by a plurality of display micro-lenses 220 disposed in close proximity to one another and the information for one pixel is synthetically generated by integrating the outputs from display pixels 211, the quantity of which corresponds to the coverage area covered by the display micro-lens 220 that forms a synthetic pupil. Thus, the outputs from the display pixels 211 can be combined to generate synthetic data without having to modify the optical system by adopting a calculation method different from that in the related art, whereby a specific type of texture present under the coverage area underneath a given display micro-lens is separated and the coverage area is then divided into a plurality of pixels.

(2) The display control unit 101g controls the display unit 201 so as to bring up a three-dimensional image and a two-dimensional image on display on a single screen. In other words, an image corresponding to three-dimensional image data obtained in, for instance, a plenoptic camera can be provided in three-dimensional display while providing a two-dimensional display of buttons, characters or the like enabling various types of operations, such as ending the display of the image currently on three-dimensional display. As a result, 2-D information can be provided in two-dimensional display in the form of a spatial image at the three-dimensional image display device 100, thereby allowing the user to view the 2-D information as he would at a display unit intended for two-dimensional image display and thus affording the maximum ease of operation.

(3) The extraction unit 101a extracts 2-D information included in three-dimensional image data as two-dimensional display data, and the 2-D output unit 101d outputs the 2-D information having been extracted by the extraction unit 101a as two-dimensional image data. Through these measures, even 2-D information such as a window frame included in three-dimensional image data can be provided in two-dimensional display, and, as a result, the user is able to view the 2-D information without difficulty.

The three-dimensional image display device 100 achieved in the embodiment as described above allows for the following variations.

(1) The present invention may be adopted in a display unit other than the display unit 201, which provides an integral three-dimensional display by adopting the principle of plenoptics. For instance, the present invention may be adopted in a display unit equipped with multi-parallax cylindrical lenses instead of the display unit 201 equipped with the display micro-lens array 202. In addition, in correspondence to each display micro-lens pixels corresponding to multiple lines of sight, each used to form image data along a direction in which a specific line of sight extends, may be included.

(2) Instead of allocating image data (pattern Pt), which correspond to a two-dimensional image, over display pixels 211 and having the display pixels 211 emit light accordingly, a member at which the pattern Pt corresponding to the two-dimensional image is reproduced may be utilized. In such a case, the member having the pattern Pt, i.e., the 2-D information, printed thereupon should be positioned between the display pixels 211 and the display micro-lenses 220 by, for instance, pasting the member onto the lower surface of the display micro-lens array 202.

As long as the features characterizing the present invention are not compromised, the present invention is in no way limited to the particulars of the embodiment described above and other modes that are conceivable within the technical scope of the present invention are also within the scope of the invention. The embodiment and variations thereof having been described above may be adopted in any conceivable combination.

The disclosures of the following priority applications are herein incorporated by reference:
Japanese Patent Application No. 2011-184728 filed Aug. 26, 2011
Japanese Patent Application No. 2012-182953 filed Aug. 22, 2012

1. A three-dimensional image display device, comprising:
an input unit that inputs image data;
a first image conversion unit that converts the image data to first image display data which include 2-D information;
a display unit having a plurality of display pixels disposed in a two-dimensional pattern, which emits light fluxes from the plurality of display pixels in correspondence to the first image display data; and
a micro-lens array having a plurality of micro-lenses disposed in a two-dimensional pattern, via which a three-dimensional image or a two-dimensional image is formed by combining the light fluxes emitted from the plurality of display pixels.

2. A three-dimensional image display device according to claim 1, further comprising:
a second image conversion unit that converts the image data to second image display data which include 3-D information, wherein:
the display unit emits light fluxes from the plurality of display pixels in correspondence to the first image display data and the second image display data.

3. A three-dimensional image display device according to claim 2, wherein:
the three-dimensional image and the two-dimensional image are displayed on a single plane.

4. A three-dimensional image display device, comprising:
a display unit having a plurality of display pixel clusters disposed in a two-dimensional array, each of the plurality of display pixel clusters including a plurality of display pixels disposed in a two-dimensional pattern;
a plurality of optical members disposed, each in correspondence to one of the plurality of display pixel clusters, in a two-dimensional array, which project the corresponding display pixel clusters;
a three-dimensional image data output unit that outputs three-dimensional image data;
a first display control unit that displays the three-dimensional image data as a three-dimensional image via the optical members by controlling the display pixels based upon the three-dimensional image data;
a two-dimensional image data output unit that outputs two-dimensional image data;
a conversion unit that divides the two-dimensional image data into a plurality of two-dimensional image data segments and converts each of the two-dimensional image data segments into a plurality of two-dimensional image display data segments; and
a second display control unit that controls the display pixel clusters each corresponding to the plurality of two-dimensional image display data segments based upon the two-dimensional image display data segments so as to display each set of the two-dimensional image data as a two-dimensional image by synthetically generating a projected image via the optical members related to the plurality of display pixel clusters corresponding to the plurality of sets of two-dimensional image display data.

5. A three-dimensional image display device, comprising:
a display unit having a plurality of display pixel clusters disposed in a two-dimensional pattern, each of the plurality of display pixel clusters including a plurality of display pixels disposed in a two-dimensional pattern;
a plurality of optical members disposed, each in correspondence to one of the plurality of display pixel clusters, in a two-dimensional array, which project the corresponding display pixel clusters;
a three-dimensional image data output unit that outputs three-dimensional image data;
a first display control unit that displays the three-dimensional image data as a three-dimensional image via the optical members by controlling the display pixels based upon the three-dimensional image data;
a two-dimensional image data output unit that outputs two-dimensional image data;
a conversion unit that divides the two-dimensional image data into a plurality of two-dimensional image data segments and converts each of the two-dimensional image data segments into a plurality of two-dimensional image display data segments;
a second display control unit that controls the display pixel clusters each corresponding to the plurality of two-dimensional image display data segments based upon the two-dimensional image display data segments so as to display each set of the two-dimensional image data as a two-dimensional image by synthetically generating a projected image via the optical members related to the plurality of display pixel clusters corresponding to the plurality of sets of two-dimensional image display data; and
a third display control unit that brings up the three-dimensional image and the two-dimensional image on display on a single screen by controlling the display unit.

6. A three-dimensional image display device according to claim 4, further comprising:
a third display control unit that brings up the three-dimensional image and the two-dimensional image on display on a single screen by controlling the display unit.

7. A three-dimensional image display device according to claim 4, further comprising:
an extraction unit that extracts 2-D information included in the three-dimensional image data, wherein:
the two-dimensional image data output unit outputs the 2-D information extracted by the extraction unit, as the two-dimensional image data.

8. A three-dimensional image display device according to claim 4, wherein:
the conversion unit is configured with a 2-D member having the two-dimensional image display data segments reproduced thereat and is disposed between the optical members and the display pixels in relation to a direction along optical axis of the optical members extend.

9. A three-dimensional image display device according to claim 4, wherein:
the optical members project the two-dimensional image onto lens surfaces of the optical members or onto an image plane in space, the image plane in space being set apart by a distance equal to a focal length of the optical members or more.

10. A three-dimensional image display device according to claim 4, wherein:
the optical members are each constituted with a micro-lens or a cylindrical lens.
